(19) United States
(12) Patent Application Publication
(10) Pub. No.: US 2026/0086497 A1
(43) Pub. Date: Mar. 26, 2026

(54) IMAGE FORMING APPARATUS

(71) Applicant: FUJIFILM Business Innovation Corp., Tokyo (JP)

(72) Inventors: Yasunobu GOTO, Kanagawa (JP); Yuya CHONABAYASHI, Kanagawa (JP); Satoshi WATANABE, Kanagawa (JP); Suguru GOTO, Kanagawa (JP); Yuki KOHNO, Kanagawa (JP); Yoshinori KODAKARI, Kanagawa (JP); Yasuhisa FUKUDA, Kanagawa (JP); Yuki KAWAZOE, Kanagawa (JP)

(73) Assignee: FUJIFILM Business Innovation Corp., Tokyo (JP)

(21) Appl. No.: 19/039,129

(22) Filed: Jan. 28, 2025

(30) Foreign Application Priority Data
Sep. 25, 2024 (JP) 2024-165870

(51) Int. Cl. G03G 21/16

(52) U.S. Cl. CPC G03G 21/168; G03G 21/1633; G03G 21/1685

(57) ABSTRACT

An image forming apparatus including: an opening and closing unit mounted on an apparatus main body so as to be opened and closed; a transfer unit that is provided on the opening and closing unit and transfers an image onto a recording medium from an image holding unit at a transfer position; a transport roller pair that transports the recording medium to the transfer position; an inclination adjustment unit that adjusts an inclination of a first transport roller, of the transport roller pair, mounted on the apparatus main body; and a positioning and fixing unit that, when the opening and closing unit is closed, positions and fixes a second transport roller, of the transport roller pair, movably mounted on the opening and closing unit, to the apparatus main body, before the transfer unit comes into contact with the image holding unit, the positioning and fixing unit allowing the second transport roller to move in an adjustment direction of the inclination adjustment unit and restricting a position of the second transport roller when the second transport roller moves to an end portion of an apparatus main body area of the apparatus main body.

### CROSS-REFERENCE TO RELATED APPLICATIONS

This application is based on and claims priority under 35 USC 119 from Japanese Patent Application No. 2024-165870 filed Sep. 25, 2024.

### BACKGROUND

### (i) Technical Field

The present disclosure relates to an image forming apparatus.

### (ii) Related Art

For example, Japanese Unexamined Patent Application Publication No. 2015-227907 has proposed and disclosed a technique related to an image forming apparatus.

In Japanese Unexamined Patent Application Publication No. 2015-227907, when a door is opened, the timing of a peak of an operation force exerted on the door by a transfer positioning member differs from the timing of a peak of an operation force exerted on the door by a roller positioning member.

### SUMMARY

Aspects of non-limiting embodiments of the present disclosure relate to, compared with when a positioning and fixing unit that positions and fixes, to an apparatus main body, a second transport roller, of a transport roller pair, mounted on an opening and closing unit does not accommodate to the movement of the second transport roller in an adjustment direction of an inclination adjustment unit, the suppressing of breakage and an operational failure of members constituting the positioning and fixing unit, resulting from the interference between the members, at the time of closing the opening and closing unit, by using the positioning and fixing unit.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: an opening and closing unit mounted on an apparatus main body so as to be opened and closed; a transfer unit that is provided on the opening and closing unit and transfers an image onto a recording medium from an image holding unit at a transfer position; a transport roller pair that transports the recording medium to the transfer position; an inclination adjustment unit that adjusts an inclination of a first transport roller, of the transport roller pair, mounted on the apparatus main body; and a positioning and fixing unit that, when the opening and closing unit is closed, positions and fixes a second transport roller, of the transport roller pair, movably mounted on the opening and closing unit, to the apparatus main body, before the transfer unit comes into contact with the image holding unit, the positioning and fixing unit allowing the second transport roller to move in an adjustment direction of the inclination adjustment unit and restricting a position of the second transport roller when the second transport roller moves to an end portion of an apparatus main body area of the apparatus main body.

### BRIEF DESCRIPTION OF THE DRAWINGS

Exemplary embodiments of the present disclosure will be described in detail based on the following figures, wherein:

FIG. 1 illustrates the overall configuration of an image forming apparatus according to a first exemplary embodiment of the present disclosure;

FIG. 2 is a perspective view illustrating an intermediate transfer unit of the image forming apparatus according to the first exemplary embodiment of the present disclosure;

FIG. 3 illustrates a related part in a state where a side covering part of the image forming apparatus according to the first exemplary embodiment of the present disclosure is opened;

FIG. 4 is a perspective view illustrating the side covering part;

FIG. 5 illustrates a related part of the image forming apparatus according to the first exemplary embodiment of the present disclosure;

FIG. 6 illustrates the related part of the image forming apparatus according to the first exemplary embodiment of the present disclosure;

FIG. 7 is a perspective view illustrating a related part in the image forming apparatus according to the first exemplary embodiment of the present disclosure;

FIG. 8 is a perspective view illustrating an inclination adjustment member;

FIG. 9 illustrates a related part of the image forming apparatus according to the first exemplary embodiment of the present disclosure; and

FIG. 10 illustrates a related part of an image forming apparatus according to a second exemplary embodiment of the present disclosure.

### DETAILED DESCRIPTION

Hereinafter, exemplary embodiments according to the present disclosure will be described with reference to the figures.

### First Exemplary Embodiment

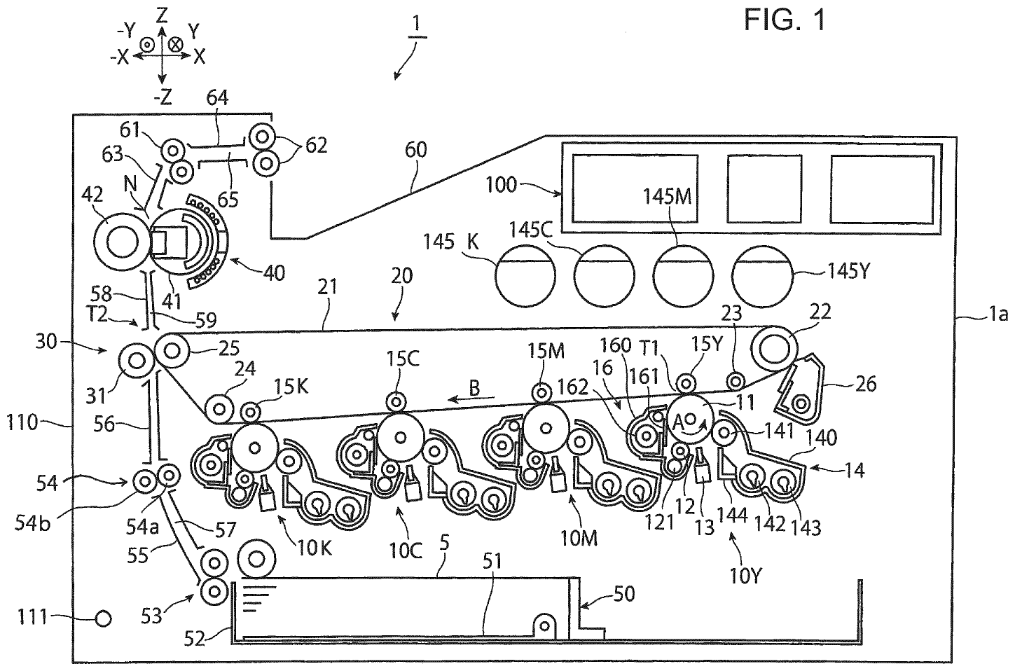

FIG. 1 schematically illustrates the overall configuration of an image forming apparatus according to a first exemplary embodiment. Note that, in the figure, arrow X indicates the horizontal direction of the image forming apparatus, arrow Y indicates the depth direction of the image forming apparatus, and arrow Z indicates the vertical direction of the image forming apparatus.

### Overall Configuration of Image Forming Apparatus

An image forming apparatus 1 is configured as, for example, a color printer. The image forming apparatus 1 includes, as FIG. 1 illustrates, for example, plural image forming devices 10, an intermediate transfer device 20, a second transfer device 30, a paper feeding device 50, and a fixing device 40. The plural image forming devices 10 each form a toner image that is developed with a toner contained in a developer. The intermediate transfer device 20 holds the toner images formed by the respective image forming devices 10 and finally transports the toner images to a second transfer position T2 where the toner images are second-transferred onto recording paper 5 that is one example of a recording medium. At the second transfer position T2, the second transfer device 30 second-transfers the toner images transported by the intermediate transfer device 20, onto the recording paper 5. The paper feeding device 50 stores and transports the required recording paper 5 to be supplied to the second transfer position T2 of the intermediate transfer device 20. The fixing device 40 fixes, on the recording paper 5, the toner images that have been second-transferred at the second transfer device 30. A reference sign 1a denotes an apparatus main body formed by, for example, a supporting structural member and an exterior covering part.

The image forming devices 10 include four image forming devices 10Y, 10M, 10C, and 10K configured to form specifically toner images in four colors: yellow (Y), magenta (M), cyan (C), and black (K), respectively. The four image forming devices 10 (Y, M, C, and K) are arranged in a row while being inclined relative to the horizontal direction X in an inner space of the apparatus main body 1a.

As FIG. 1 illustrates, each of the image forming devices 10 (Y, M, C, and K) includes a photoconductor drum 11 that rotates in a direction of arrow A. In the vicinity of the photoconductor drum 11, a charging device 12, an exposure device 13, a developing device 14, a first transfer device 15, and a drum cleaner 16, for example, are disposed. The charging device 12 is constituted by a charging roller that charges, to a required potential, a peripheral surface (image holding surface), of the photoconductor drum 11, on which an image can be formed. The charging device 12 includes a cleaning roller 121 that cleans a surface of the charging device 12. The exposure device 13 irradiates the charged peripheral surface of the photoconductor drum 11 with the light based on information (signal) of an image and forms an electrostatic latent image (for a corresponding color) having a potential difference. The developing device 14 develops the electrostatic latent image into a toner image, with a toner of a developer in a corresponding color (Y, M, C, or K). The first transfer device 15 transfers the corresponding toner image onto the intermediate transfer device 20. The drum cleaner 16 performs cleaning by removing a deposit such as a toner remaining on and adhering to the image holding surface of the photoconductor drum 11 after first transfer.

The developing devices 14 (Y, M, C, and K) are each configured by disposing, inside a housing 140, for example, a developing roller 141, stirring and transporting members 142 and 143, and a layer-thickness-regulating member 144. The housing 140 has an opening portion and a storage chamber for the developer. The developing roller 141, while holding, transports the developer to a developing region facing the photoconductor drum 11. The stirring and transporting members 142 and 143 are each constituted by, for example, a screw auger that, while stirring, transports the developer so as to cause the developer to pass through the developing roller 141. The layer-thickness-regulating member 144 regulates the amount (thickness) of the developer held by the developing roller 141. Note that, for each of the developers in the four colors (Y, M, C, and K), a two-component developer containing a nonmagnetic toner and a magnetic carrier is used.

Each of the developing devices 14 (Y, M, C, and K) is replenished with a toner in a corresponding color through a toner replenishment device (not illustrated) from a corresponding one of toner cartridges 145 (Y, M, C, and K) of yellow (Y), magenta (M), cyan (C), and black (K) disposed above the intermediate transfer device 20.

The first transfer device 15 is a contact-type transfer device including a first transfer roller that rotates while being in contact with the peripheral surface of the photoconductor drum 11 with an intermediate transfer belt 21 therebetween at the first transfer position T1 and is supplied with a first transfer voltage. A DC voltage or current having a polarity opposite to the charge polarity of the toner is supplied, as the first transfer voltage, from a high-voltage power supply.

The drum cleaner 16 is constituted by, for example, a cleaning blade 161 and a sending member 162 that are disposed inside a main body 160 having a container shape. The cleaning blade 161 performs cleaning by removing a deposit such as a residual toner. The sending member 162 collects a deposit such as the toner that has been removed by the cleaning blade 161 and transports the deposit off to a collection system (not illustrated).

The intermediate transfer device 20 is disposed above each of the image forming devices 10 (Y, M, C, and K). The intermediate transfer device 20 is constituted by, for example, the intermediate transfer belt 21, plural belt supporting rollers 22 to 25, and a belt cleaner 26. The intermediate transfer belt 21 is circularly moved in a direction indicated by arrow B while passing through the first transfer positions T1 between the photoconductor drums 11 and the respective first transfer devices 15 (the first transfer rollers). The plural belt supporting rollers 22 to 25 supports the intermediate transfer belt 21 such that the intermediate transfer belt 21 is movable, while holding the intermediate transfer belt 21 from an inner peripheral portion of the intermediate transfer belt 21 in a requested state. The belt cleaner 26 performs cleaning by removing deposits such as the toner and paper dust that have remained on an outer peripheral surface of the intermediate transfer belt 21 after passing through the second transfer device 30.

The belt supporting roller 22 serves as a driving roller. The belt supporting roller 23 serves as a flattening roller for maintaining the intermediate transfer belt 21 in a running position. The belt supporting roller 24 serves as a sensor roller facing a sensor (not illustrated). The belt supporting roller 25 serves as a backup roller of the second transfer device 30.

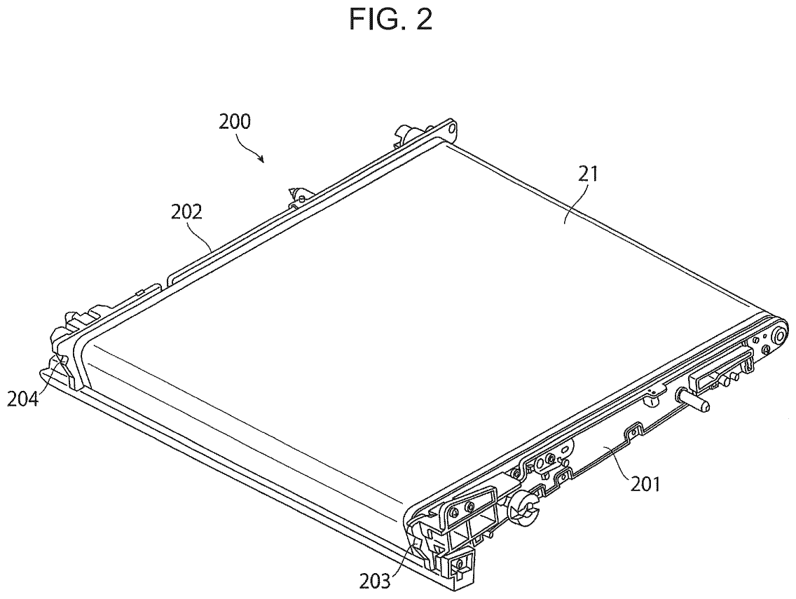

As FIG. 2 illustrates, the intermediate transfer device 20 of the image forming apparatus 1 is integrated, with the intermediate transfer belt 21 and the plural belt supporting rollers 22 to 25 and also the first transfer devices 15 (Y, M, C, and K), into an intermediate transfer unit 200. The intermediate transfer unit 200 is detachably attached to the apparatus main body 1a.

The intermediate transfer unit 200 includes side frames 201 and 202 on the front side and the rear side disposed in end portions on both sides in a width direction crossing a movement direction of the intermediate transfer belt 21. The belt supporting rollers 22 to 25 and the first transfer devices 15 are rotatably supported by both the side frames 201 and 202. The side frames 201 and 202 on the front side and the rear side have positioning recess portions 203 and 204 for positioning a second transfer roller 31 of the second transfer device 30, respectively. The positioning recess portions 203 and 204 are disposed in an end portion, in the horizontal direction X, corresponding to the belt supporting roller 25 functioning as the backup roller. The intermediate transfer unit 200 is mounted and fixed in a predetermined position of the apparatus main body 1a of the image forming apparatus 1. As a result, with the intermediate transfer unit 200, the positioning recess portions 203 and 204 are disposed, while being fixed, in a predetermined position of the apparatus main body 1a area of the image forming apparatus 1.

The second transfer device 30 includes, as FIG. 1 illustrates, the second transfer roller 31 that rotates at the second transfer position T2 that is an outer peripheral surface portion of the intermediate transfer belt 21 supported by the belt supporting roller 25 in the intermediate transfer device 20. The second transfer roller 31 or the belt supporting roller 25 of the intermediate transfer device 20 is supplied with, as a second transfer voltage, a DC voltage having the opposite polarity or the same polarity as the charging polarity of the toner.

The fixing device 40 is configured by disposing, for example, a heating rotary body 41 and a pressing rotary body 42. The heating rotary body 41 is a member in the form of belt or roller and is heated by a heating method/unit such as electromagnetic induction heating or a heat source such that the surface temperature of the heating rotary body 41 is maintained at a predetermined temperature. The pressing rotary body 42 is a member in the form of roller or belt and rotates while being in contact with the heating rotary body 41 with a required pressure. In the fixing device 40, a contact part where the heating rotary body 41 and the pressing rotary body 42 are in contact with each other serves as a fixing process part N where a required fixing process (heating and pressing) is performed.

The paper feeding device 50 is disposed below the image forming devices 10 (Y, M, C, and K). The paper feeding device 50 includes a single (or plural) sheet storage body 52 and a feeder 53. The sheet storage body 52 stores the recording paper 5 of, for example, requested size and type with the recording paper 5 stacked on a stacking plate 51. The feeder 53 feeds the recording paper 5 from the sheet storage body 52 one by one. The sheet storage body 52 is installed so as to be drawn, for example, to the front side (a side a user faces when operating) of the apparatus main body 1a.

A paper-feeding transport path 57 is provided between the paper feeding device 50 and the second transfer device 30. The paper-feeding transport path 57 is constituted by a single (or plural) sheet transport roller pair 54 and transport guide members 55 and 56 that transport the recording paper 5 fed from the paper feeding device 50, to the second transfer position T2. The sheet transport roller pair 54 disposed immediately in front of the second transfer position T2 on the paper-feeding transport path 57 serves as, for example, a roller (registration roller) for adjusting a transport timing of the recording paper 5.

In addition, a sheet transport path 59 is provided between the second transfer device 30 and the fixing device 40. The sheet transport path 59 is constituted by, for example, a transport guide member 58 that transports the recording paper 5 fed from the second transfer device 30, to the fixing device 40.

A discharge transport path 65 is provided downstream of the fixing device 40. The discharge transport path 65 is provided with, for example, a sheet transport roller pair 61, a sheet discharge roller pair 62, and transport guide members 63 and 64. The sheet transport roller pair 61, the sheet discharge roller pair 62, and the transport guide members 63 and 64 discharge the recording paper 5 on which a toner image is fixed by the fixing device 40, to a sheet discharge part 60 disposed on an upper portion of the apparatus main body 1a.

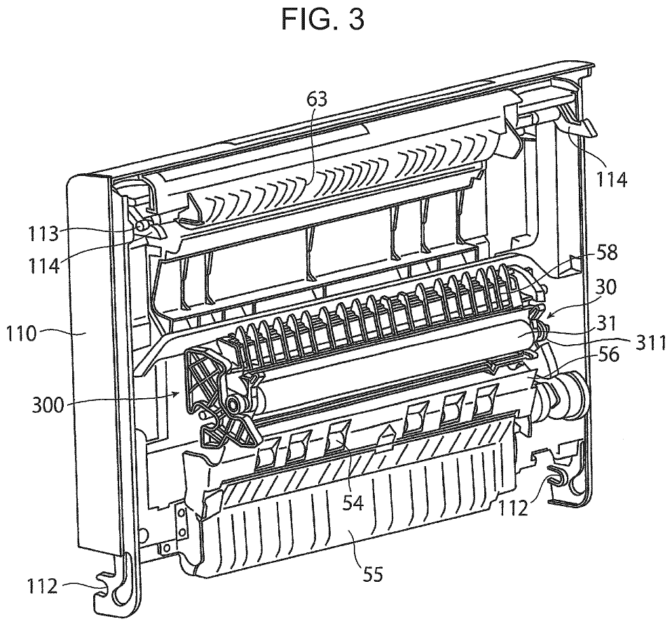

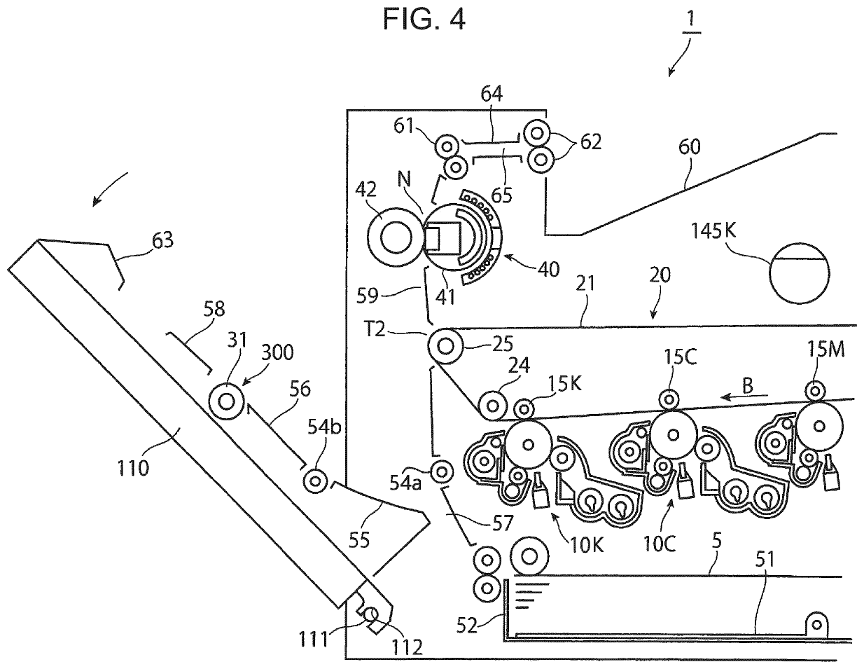

In the first exemplary embodiment, as FIG. 3 illustrates, there is provided a side covering part 110 that is one example of an opening and closing unit mounted on the apparatus main body 1a so as to be opened and closed. The side covering part 110 is rotatably mounted on a pivot 111 provided in a lower end portion of a left side of the apparatus main body 1a, by using an engagement portion 112 that is formed by a recessed portion and/or an insertion hole provided in a lower end portion of the side covering part 110. In addition, an upper end portion of the side covering part 110 includes, as FIG. 4 illustrates, a locking member 114 that locks the side covering part 110 in a closed state, by being locked by a locking portion 113 having a circular columnar shape and provided in the apparatus main body 1a area through an operation on an operation part (not illustrated) when the side covering part 110 is opened and closed.

In the image forming apparatus 1, the side covering part 110 is opened and closed, for example, when a transport failure (so-called jam) of the recording paper 5 occurs on, for example, the paper-feeding transport path 57, the sheet transport path 59, or the discharge transport path 65. Through the above operation, the paper-feeding transport path 57, the sheet transport path 59, or the discharge transport path 65 is exposed outside, and the recording paper 5 on which the transport failure has occurred is removed, for example. At this time, a pinch roller 54b that is a second transport roller, of the transport rollers constituting the sheet transport roller pair 54, mounted on the side covering part 110 is separated from a registration roller 54a that is a first transport roller, of the transport rollers constituting the sheet transport roller pair 54, mounted on the apparatus main body 1a. Similarly, the second transfer roller 31 mounted on the side covering part 110 is separated from the belt supporting roller 25 mounted on the apparatus main body 1a.

In FIG. 1, a reference sign 100 denotes a controller that is one example of a control unit that comprehensively controls the operation of the image forming apparatus 1.

### Basic Operation of Image Forming Apparatus

Hereinafter, a basic image forming operation performed by the image forming apparatus 1 will be described.

Here, the image forming operation performed when a full-color image obtained by combining toner images of four colors (Y, M, C, and K) is formed by using the four image forming devices 10 (Y, M, C, and K) will be described. Note that, when a single-color image or an image obtained by combining toner images of plural colors is formed by using at least one of the four image forming devices 10 (Y, M, C, and K), the image forming operation is performed basically in a similar manner.

When receiving command information requesting an image forming operation (printing), in the image forming apparatus 1, under the control of the controller 100, for example, the four image forming devices 10 (Y, M, C, and K), the intermediate transfer device 20, the second transfer device 30, and the fixing device 40 are started to operate.

In each of the image forming devices 10 (Y, M, C, and K), as FIG. 1 illustrates, first, the photoconductor drum 11 rotates in the direction indicated by arrow A, and the charging device 12 charges the surface of the photoconductor drum 11 to the required polarity and potential. Next, the exposure device 13 irradiates the charged surface of the photoconductor drum 11 with the light emitted based on a signal of an image, and the signal is obtained by converting the information of the image input into the image forming apparatus 1, into a corresponding color component (Y, M, C, or K). An electrostatic latent image of the corresponding color component with a required potential difference is then formed on the surface of the photoconductor drum 11.

Next, each of the developing devices 14 (Y, M, C, and K) develops the electrostatic latent image of the corresponding color component formed on the photoconductor drum 11, by supplying and causing the toner of the corresponding color (Y, M, C, or K) that has been charged to the required polarity, to adhere electrostatically to the electrostatic latent image. Through this development, the electrostatic latent images of the color components formed on the respective photoconductor drums 11 are rendered visible as the toner images of the four colors (Y, M, C, and K) developed with the respective color toners.

Next, the toner images of the four colors formed on the photoconductor drums 11 of the image forming devices 10 (Y, M, C, and K) are transported to the respective first transfer positions T1. Then, the first transfer devices 15 first-transfer the toner images of the respective colors, while laying the toner images one on top of another in order, onto the intermediate transfer belt 21, of the intermediate transfer device 20, rotating in the direction indicated by arrow B.

In addition, in each of the image forming devices 10 (Y, M, C, and K) after the first transfer ends, the drum cleaner 16 cleans the surface of the photoconductor drum 11 by removing a deposit in a scraping manner. Thus, each of the image forming devices 10 (Y, M, C, and K) stands ready for a next image forming operation.

Next, the intermediate transfer device 20 transports, while holding, the first-transferred toner images to the second transfer position T2 by the rotation of the intermediate transfer belt 21. On the other hand, the paper feeding device 50 feeds the required recording paper 5 to the paper-feeding transport path 57 according to the image forming operation. On the paper-feeding transport path 57, the sheet transport roller pair 54 serving as the registration roller supplies, by feeding, the recording paper 5 to the second transfer position T2 in accordance with a transfer timing.

At the second transfer position T2, the second transfer roller 31 second-transfers collectively the toner images on the intermediate transfer belt 21, onto the recording paper 5. In addition, in the intermediate transfer device 20 after the second transfer ends, the belt cleaner 26 performs cleaning by removing a deposit such as a toner remaining on the surface of the intermediate transfer belt 21 after performing the second transfer.

Next, the recording paper 5 onto which the toner images have been second-transferred is separated from the intermediate transfer belt 21 and the second transfer roller 31 and is then transported to the fixing device 40 along the sheet transport path 59. In the fixing device 40, the recording paper 5 after the second transfer is introduced into the fixing process part N positioned between the heating rotary body 41 and the pressing rotary body 42 and passes through the fixing device 40. Thus, the unfixed toner images are fixed to the recording paper 5 by performing a required fixing process (heating and pressing). The recording paper 5 after the fixing ends is discharged by the sheet discharge roller pair 62 through the discharge transport path 65 to the sheet discharge part 60 provided on the upper portion of the apparatus main body 1a.

By the above operations, the full-color image obtained by combining the toner images of the toners of the four colors (Y, M, C, and K) is output.

### Configuration of Sheet Transport Roller Pair

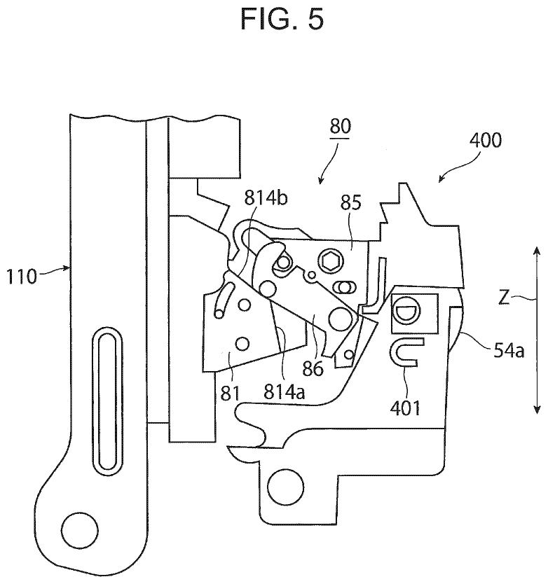

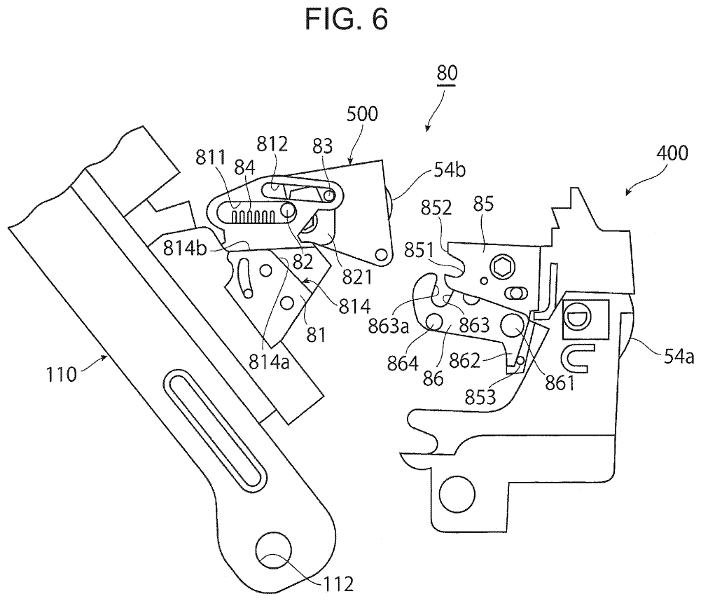

The image forming apparatus 1 according to the first exemplary embodiment includes, as FIG. 1 illustrates, the sheet transport roller pair 54 serving as the transport roller pair that transports the recording paper 5 to the second transfer position T2 as described above. The sheet transport roller pair 54 is constituted by the registration roller 54a and the pinch roller 54b. As FIG. 5 illustrates, the registration roller 54a is rotatably mounted on a registration unit 400 that is one example of a first unit. The registration unit 400 is installed while being fixed to the apparatus main body 1a. The registration roller 54a is rotationally driven by a driving unit (not illustrated) provided on the apparatus main body 1a. As FIG. 6 illustrates, the pinch roller 54b is rotatably mounted on a pinch unit 500 that is one example of a second unit. The pinch unit 500 is movably mounted on the side covering part 110. The pinch roller 54b is driven to rotate by being in contact with the registration roller 54a.

During feeding, the sheet transport roller pair 54 corrects skewing of the recording paper 5 by hitting a leading edge of the recording paper 5 against a nip part of the registration roller 54a and the pinch roller 54b that are stopped. Subsequently, in the sheet transport roller pair 54, the registration roller 54a is rotationally driven to transport the recording paper 5 to the second transfer position T2 in cooperation with the pinch roller 54b. At this time, in the image forming apparatus 1, misregistration occurs in an image that is transferred onto the recording paper 5 when there is a difference in parallelism between the registration roller 54a and the second transfer roller 31 disposed at the second transfer position T2.

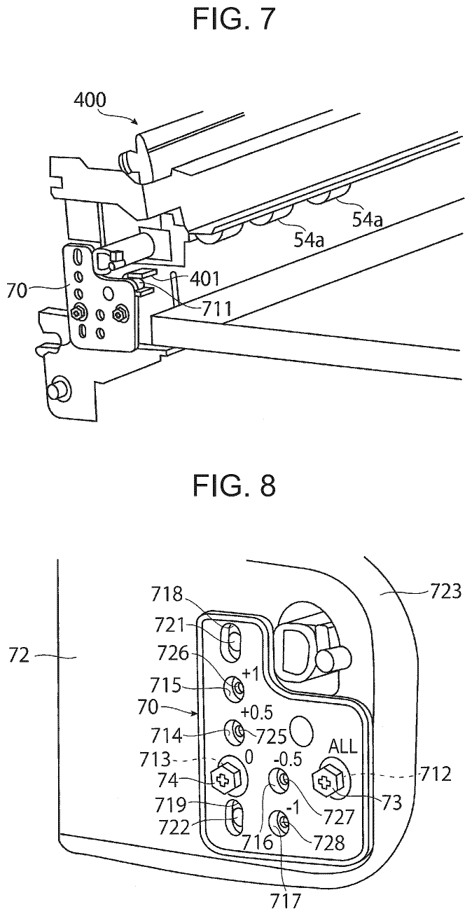

Thus, the image forming apparatus 1 includes an inclination adjustment member 70 that is one example of an inclination adjustment unit capable of correcting the misregistration of the image that is transferred onto the recording paper 5, by adjusting the inclination of the registration roller 54a. As FIG. 7 illustrates, the inclination adjustment member 70 is disposed on each of both end portions of a rotating shaft of the registration roller 54a in the axial direction, that is, in the longitudinal direction of the registration unit 400. Note that FIG. 7 illustrates the state where a frame of the apparatus main body 1a is removed.

As FIG. 8 illustrates, the inclination adjustment member 70 is made of, for example, a synthetic resin and formed into a flat plate shape having a substantially rectangular side and having an upper end whose one side (the left side in the figure) protrudes upward. A shaft portion 711 (refer to FIG. 7) having a hollow cylindrical shape or a circular columnar shape is provided on the back side of the inclination adjustment member 70 so as to protrude inward. As FIG. 5 illustrates, a support portion 401 that is open sideward is provided on each of both end faces, in the longitudinal direction, of the registration unit 400. As FIG. 7 illustrates, the support portion 401 of the registration unit 400 adjusts the height, in the vertical direction Z, of the registration unit 400 by being fitted around the shaft portion 711 of the inclination adjustment member 70. The registration unit 400 is installed so as to move in the vertical direction Z relative to the apparatus main body 1a.

As FIG. 8 illustrates, the inclination adjustment member 70 is mounted on a frame 72 on each of the front side and the rear side of the apparatus main body 1a such that the height in the vertical direction Z is adjustable. The inclination adjustment member 70 has one common hole 712, plural (five in the illustrated example) adjustment holes 713 to 717, and two sliding holes 718 and 719. The plural adjustment holes 713 to 717 are for adjusting the height, in the vertical direction Z, of the registration unit 400. The common hole 712 is an elongated hole extending in the vertical direction Z. On the other hand, the plural adjustment holes 713 to 717 are each an elongated hole extending in the horizontal direction X. The two sliding holes 718 and 719 are each an elongated hole extending in the vertical direction Z. The two sliding holes 718 and 719 are engaged with two protrusions 721 and 722, respectively, and the two protrusions 721 and 722 are arranged on the frame 72 of the apparatus main body 1a, one above the other, in the vertical direction Z. Thus, the inclination adjustment member 70 is held so as to move in the vertical direction Z relative to the frame 72 of the apparatus main body 1a, with the position of the inclination adjustment member 70 in the horizontal direction X being restricted by the two sliding holes 718 and 719 and the two protrusions 721 and 722. Note that, in the frame 72 of the apparatus main body 1a, regions 723 corresponding to the respective inclination adjustment members 70 protrude to the front side and the rear side.

The frame 72 of the apparatus main body 1a has plural screw holes 724 to 728 that correspond to the plural adjustment holes 713 to 717 of the inclination adjustment member 70, respectively. The inclination adjustment member 70 adjusts the height of an end portion, in the longitudinal direction, of the registration unit 400 by selecting the common hole 712 and any one of the plural adjustment holes 713 to 717 and by fastening screws 73 and 74 into the screw holes 724 to 728 of the apparatus main body 1a. Note that the screw holes 724 and 725 are omitted because the screws 73 and 74 are fastened thereinto in FIG. 8.

Numerical values such as “−1“, “−0.5”, “0”, “+0.5”, and “+1” that represent adjustment levels of the height are marked, on the inclination adjustment member 70, beside the adjustment holes 713 to 717. For example, by selecting the adjustment hole 713 marked as “0” and fastening the screw 74 into the screw hole 724 corresponding to “0” of the frame of the apparatus main body 1a, the inclination adjustment member 70 is fixed in the position (height) serving as a reference. Similarly, for example, by selecting the adjustment hole 714 marked as “+0.5” and fastening the screw 74 into the screw hole 725 corresponding to “+0.5” of the frame of the apparatus main body 1a, the inclination adjustment member 70 is fixed in the position higher than the reference position by the amount equivalent to ”+0.5”.

The inclination adjustment member 70 is disposed on each of both the end portions on the front side and the rear side, in the longitudinal direction, of the registration unit 400 as described above. However, the inclination adjustment member 70 on the rear side is usually fixed to the apparatus main body 1a by using the adjustment hole 713 of “0” serving as the reference. Only with the inclination adjustment member 70 on the front side, the inclination of the registration roller 54a is adjusted by adjusting the height of the registration unit 400, that is, the height of an end portion on the front side, in the axial direction, of the registration roller 54a mounted on the registration unit 400. This inclination adjustment of the registration roller 54a is basically performed at the time of shipment of the image forming apparatus 1. Note that the inclination adjustment of the registration roller 54a is not limited to the case where the inclination of the registration roller 54a is adjusted only with the inclination adjustment member 70 on the front side. The inclination of the registration roller 54a may be adjusted with the inclination adjustment members 70 on both the front side and the rear side.

In addition, the image forming apparatus according to the first exemplary embodiment includes a positioning and fixing unit that, at the time of closing the opening and closing unit, before a transfer unit comes into contact with an image holding unit, positions and fixes, to the apparatus main body, the second transport roller, of the transport roller pair, movably mounted on the opening and closing unit.

As FIG. 3 illustrates, the pinch roller 54b that is the second transport roller of the sheet transport roller pair 54 and the second transfer roller 31 of the second transfer device 30, for example, are mounted on the side covering part 110. The pinch roller 54b and the second transfer roller 31 are positioned and fixed in respective operation positions where the pinch roller 54b and the second transfer roller 31 are in contact with the registration roller 54a and the belt supporting roller 25, respectively, by rotating the side covering part 110 in a direction where the side covering part 110 is closed and then by fixing the side covering part 110 in a predetermined position of the apparatus main body 1a of the image forming apparatus 1.

At this time, the pinch roller 54b mounted on the side covering part 110 is positioned in the operation position where the pinch roller 54b comes into contact with the registration roller 54a before the second transfer roller 31. Subsequently, the second transfer roller 31 mounted on the side covering part 110 is positioned in the operation position where the second transfer roller 31 is in contact with the belt supporting roller 25. In the above way, the image forming apparatus 1 may reduce the operation force at the time of closing the side covering part 110.

A positioning and fixing unit 80 includes, as FIG. 6 illustrates, a guide member 81 that is one example of the holding unit holding the pinch unit 500 on the side covering part 110 such that the pinch unit 500 is movable. The guide member 81 is disposed on each of both end portions, in the longitudinal direction, of the pinch unit 500 that is the axial direction of the pinch roller 54b. The guide member 81 is constituted by, for example, a metal sheet formed into a predetermined shape by press work, a molded synthetic resin item, or a combination of such items. The guide member 81 is installed while being fixed to an inner surface of the side covering part 110. Two studs 82 and 83 constituting part of the positioning and fixing unit 80 are disposed on both sides, in the longitudinal direction, of the pinch unit 500. The two studs 82 and 83 are installed so as to protrude outward from both the sides, in the longitudinal direction, of the pinch unit 500. The two studs 82 and 83 are constituted by a main stud 82 and an auxiliary stud 83, respectively. The main stud 82 is formed into a circular columnar shape having an outside diameter larger than the auxiliary stud 83. The main stud 82 is disposed on an end portion of the pinch unit 500 closer to the side covering part 110. The main stud 82 may be provided directly on the pinch unit 500 or may be provided, for example, by fixing a mounting plate 821 implanted with the main stud 82 to a side of the pinch unit 500 by, for example, screwing. On the other hand, the auxiliary stud 83 is disposed on an upper portion of the pinch unit 500 closer to the center.

The guide member 81 has, in an upper end portion thereof, first and second slit holes 811 and 812 substantially parallel to each other. The first and second slit holes 811 and 812 are each formed into a narrow-and-long linear shape or a slightly curved ellipse shape. The first and second slit holes 811 and 812 are each disposed in an inclined manner with an end portion on the apparatus main body 1a side (the right side in the figure) being positioned lower in the vertical direction Z. The first slit hole 811 is in a position in the guide member 81 closer to the side covering part 110 (closer to the left in the figure). In addition, the second slit hole 812 is positioned above the first slit hole 811 in the vertical direction Z and closer to the apparatus main body 1a (closer to the right in the figure).

Through the main and auxiliary studs 82 and 83 and the first and second slit holes 811 and 812, the pinch unit 500 is movable in a direction where the pinch unit 500 contacts or separates from the apparatus main body 1a, that is, the pinch unit 500 is movably mounted on the side covering part 110. In addition, the pinch unit 500 is biased toward the apparatus main body 1a by a compression spring 84 that is one example a biasing member. The compression spring 84 is interposed between the side covering part 110 and the pinch unit 500, at each of both the end portions, in the longitudinal direction, of the pinch unit 500.

As FIGS. 5 and 6 illustrate, an inclined portion 814 is also provided on an outer surface of the guide member 81 and is constituted by a step formed by a region on the side covering part 110 side protruding outward (toward the front side in the figure). The inclined portion 814 comes into contact with a contact portion 864 of a fixing arm 86 provided on the registration unit 400, at the time of closing the side covering part 110, and the inclined portion 814 rotates the fixing arm 86 in the clockwise direction. The inclined portion 814 includes a first inclined portion 814a and a second inclined portion 814b. The first inclined portion 814a rotates the fixing arm 86 in the clockwise direction to a predetermined fixation position by coming into contact with the contact portion 864 of the fixing arm 86. The second inclined portion 814b holds the fixing arm 86 in the fixation position. As FIG. 5 illustrates, the second inclined portion 814b is formed into a linear shape extending outward in the radial direction connecting a pivot 861 of the fixing arm 86 and the contact portion 864. Thus, when the contact portion 864 moves along the second inclined portion 814b, the fixing arm 86 will not rotate any further in the clockwise direction.

On the other hand, as FIG. 6 illustrates, a positioning member 85 serving as a fixing unit constituting part of the positioning and fixing unit 80 is disposed on the apparatus main body 1a. The positioning member 85 is provided on each of both the end portions, in the longitudinal direction, of the registration unit 400 and on the end portions, on the side covering part 110 side, of upper end regions of the registration unit 400, while being fixed by, for example, screwing. The positioning member 85 is made of, for example, a synthetic resin and formed into an inverted-triangular flat plate shape whose base is positioned at the top in front view. An end portion of the positioning member 85 on the side covering part 110 side (the left side in FIG. 6) has a positioning recess portion 851 that is one example of a first recess portion that performs positioning by being fitted around the main stud 82 of the pinch unit 500. The positioning recess portion 851 is formed into a substantially U shape that is open toward the side covering part 110.

The positioning member 85 is also provided with the fixing arm 86 constituting part of the fixing unit that fixes the pinch unit 500 in the operation position by being engaged with the main stud 82 of the pinch unit 500. The fixing arm 86 is made of, for example, a metal sheet or a synthetic resin and formed into, in front view, a substantially rectangular shape that is narrow and long. The fixing arm 86 is mounted on the positioning member 85 so as to rotate about the pivot 861 provided in the positioning member 85. A stopper piece 862 protrudes downward in the vicinity of the pivot 861 of the fixing arm 86. A rotation position of the stopper piece 862 of the fixing arm 86 in the counterclockwise direction is restricted by the contact with a stop pin 853 of the positioning member 85.

Moreover, a distal end of the fixing arm 86 has a fixing recess portion 863 that is one example of a second recess portion being open in a circumferential direction crossing the longitudinal direction of the fixing arm 86. As FIG. 6 illustrates, the fixing recess portion 863 of the fixing arm 86 is set such that an opening direction thereof crosses an opening direction of the positioning recess portion 851 of the positioning member 85. As a result, the main stud 82 of the pinch unit 500 is positioned in the vertical direction Z by the positioning recess portion 851 of the positioning member 85. In addition, the main stud 82 of the pinch unit 500 is positioned in the horizontal direction X by the fixing recess portion 863 of the fixing arm 86. The main stud 82 of the pinch unit 500 is biased in a direction where the main stud 82 protrudes from the positioning recess portion 851 by a repulsive force exerted when the pinch roller 54b of the pinch unit 500 is in contact with the registration roller 54a. Thus, the main stud 82 of the pinch unit 500 is positioned and fixed while remaining in contact with a surface, on the distal end side, of the fixing recess portion 863 by the repulsive force.

In the image forming apparatus 1 according to the first exemplary embodiment, as described above, the inclination of the registration roller 54a of the sheet transport roller pair 54 is adjustable by the inclination adjustment member 70.

Thus, in an image forming apparatus 1 before applied with the first exemplary embodiment of the present disclosure, the height of the registration roller 54a is changed when the inclination of the registration roller 54a is adjusted by the inclination adjustment member 70. Then, with the change in the height of the registration roller 54a, the position (height) of the positioning recess portion 851 of the positioning member 85 provided on the registration unit 400 is changed. As a result, when the side covering part 110 is closed, interference occurs between members such as the main stud 82 in the pinch unit 500 area constituting the positioning and fixing unit 80 and the positioning recess portion 851 of the positioning member 85 in the registration unit 400 area constituting the positioning and fixing unit 80. Thus, damage in the positioning recess portion 851 of the positioning member 85 may be caused, or the main stud 82 may shift from the positioning recess portion 851 to hinder the pinch unit 500 from being positioned in a proper operation position, which may cause an operation failure.

Thus, the image forming apparatus according to the first exemplary embodiment is configured such that the positioning and fixing unit allows the second transport roller to move in an adjustment direction of the inclination adjustment unit and restricts the position of the second transport roller when moving to an end portion of the apparatus main body area.

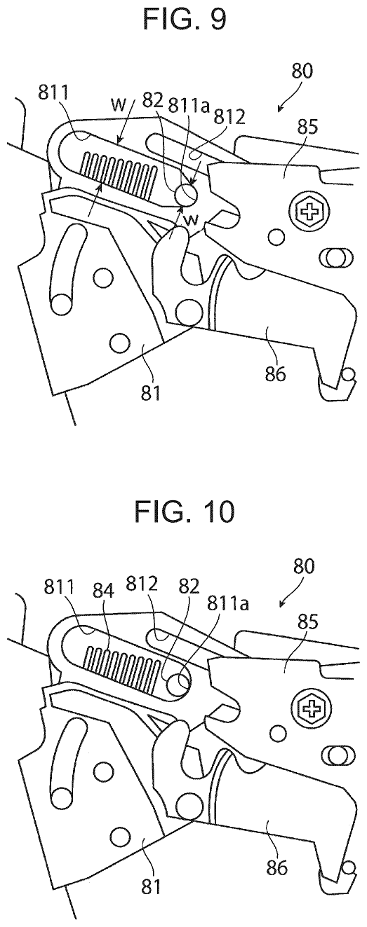

That is, as FIG. 9 illustrates, in the image forming apparatus 1 according to the first exemplary embodiment, an opening width W of the first slit hole 811 of the guide member 81 constituting the positioning and fixing unit 80 is set far larger than the outside diameter of the main stud 82. As a result, through the main stud 82, the pinch unit 500 is allowed to move in the vertical direction Z according to the opening width W of the first slit hole 811. A movement amount of the pinch unit 500 in the vertical direction Z is set, for example, approximately equal to a movement amount by which the registration unit 400 is moved by the inclination adjustment member 70 in the vertical direction Z. However, the movement amount of the pinch unit 500 may be set larger than the movement amount of the registration unit 400.

In addition, as FIG. 9 illustrates, the image forming apparatus 1 according to the first exemplary embodiment is configured to restrict the position of the pinch unit 500 when moving to the end portion of the apparatus main body 1a area. As described above, the pinch unit 500 is allowed to move in the vertical direction Z by setting the opening width W of the first slit hole 811 of the guide member 81 large.

However, in the case where the opening width W of the first slit hole 811 of the pinch unit 500 is far larger than the outside diameter of the main stud 82, the position of the main stud 82 in the vertical direction Z may be failed to be fixed when the pinch unit 500 moves to the end portion of the apparatus main body 1a area, that is, when the main stud 82 moves to an end portion, in the longitudinal direction, of the first slit hole 811.

Thus, in the first exemplary embodiment, the pinch unit 500 is allowed to move in the vertical direction Z, and the position of the pinch unit 500 when moving to the end portion of the apparatus main body 1a area is restricted uniformly. Specifically, an opening width W of an end portion 811a, in the longitudinal direction, of the first slit hole 811 is set smaller than an opening width W of the other region and is set substantially equal to the outside diameter of the main stud 82. Thus, when the main stud 82 moves to the end portion 811a, in the longitudinal direction, of the first slit hole 811, the position of the main stud 82 is restricted uniformly.

As a result, when the side covering part 110 is closed, the main stud 82 of the pinch unit 500 is movable in the vertical direction Z. Thus, even when the height, in the vertical direction Z, of the registration unit 400 in the apparatus main body 1a area is changed by the adjustment performed by the inclination adjustment member 70, the main stud 82 of the pinch unit 500 can follow the change in the height of the registration unit 400 in the vertical direction Z. Then, the main stud 82 of the pinch unit 500 may be reliably fitted into the positioning recess portion 851 of the positioning member 85 in the registration unit 400.

In an upper part of the positioning recess portion 851, a guide portion 852 that guides the main stud 82 to the inside of the positioning recess portion 851 is formed into a curved shape protruding downward. Thus, the main stud 82 of the pinch unit 500 may be reliably guided into the positioning recess portion 851 by the guide portion 852 even when the relative position, in the vertical direction Z, of the main stud 82 is shifted relative to the positioning recess portion 851 of the positioning member 85.

The main stud 82 of the pinch unit 500 positioned by the positioning recess portion 851 is fixed by the fixing recess portion 863 of the fixing arm 86.

In such a case, the fixing recess portion 863 of the fixing arm 86 is formed into a circular arc shape, and an inner surface on the outer peripheral side extends around the pivot 861. The surface, on the outer peripheral side, of the fixing recess portion 863 defines an inter-axis distance of the registration roller 54a mounted on the registration unit 400 and the pinch roller 54b of the pinch unit 500 positioned and fixed relative to the registration unit 400 by the positioning and fixing unit 80.

Thus, by forming the fixing recess portion 863 of the fixing arm 86 into a circular arc shape in which an inner surface 863a thereof on the outer peripheral side extends around the pivot 861, the inter-axis distance of the registration roller 54a and the pinch roller 54b is always maintained constant even when the stop position of the fixing arm 86 that fixes the main stud 82 of the pinch unit 500 varies.

### Configuration of Second Transfer Device

The second transfer device 30 includes, as FIG. 1 illustrates, the second transfer roller 31 that is one example of a transfer unit. The second transfer roller 31 rotates at the second transfer position T2 that is an outer peripheral surface portion of the intermediate transfer belt 21 that is one example of an image holding unit. The intermediate transfer belt 21 is supported by the belt supporting roller 25 in the intermediate transfer device 20.

In the first exemplary embodiment, as FIG. 3 illustrates, the second transfer device 30 constitutes a second transfer unit 300 detachably attached to the side covering part 110 that is one example of the opening and closing unit of the apparatus main body 1a.

The second transfer roller 31 of the second transfer device 30 is rotatably mounted on the second transfer unit 300. The second transfer unit 300 includes a bearing member 311 disposed on each of both end portions, in the axial direction, of the second transfer roller 31. In the second transfer unit 300, when the side covering part 110 is closed, the second transfer roller 31 is positioned and fixed in an operation position in the apparatus main body 1a by the contact of the bearing members 311 with the positioning recess portions 203 and 204 of the intermediate transfer unit 200.

As FIG. 3 illustrates, the second transfer unit 300 is mounted, on the inner surface of the side covering part 110, at a position farther from the pivot 111 than the pinch unit 500. Thus, when the side covering part 110 is rotated in the clockwise direction about the pivot 111 to be closed, the movement amount by which the second transfer unit 300 moves is larger than that of the pinch unit 500.

As a result, when the side covering part 110 is closed, the pinch unit 500 comes into contact with the registration unit 400 in the apparatus main body 1a area through the positioning and fixing unit before the second transfer unit 300, and the pinch unit 500 is positioned and fixed by the positioning and fixing unit. Subsequently, the second transfer unit 300 comes into contact with the intermediate transfer unit 200 provided in the apparatus main body 1a area through the bearing member 311 and is positioned and fixed by the positioning recess portions 203 and 204.

### Operation of Image Forming Apparatus

In the image forming apparatus according to the first exemplary embodiment, compared with when the positioning and fixing unit that positions and fixes, to the apparatus main body, the second transport roller, of the transport roller pair, mounted on the opening and closing unit does not accommodate to the movement of the second transport roller in the adjustment direction of the inclination adjustment unit, the positioning and fixing unit may suppress breakage and an operational failure of members constituting the positioning and fixing unit, resulting from the interference between the members, at the time of closing the opening and closing unit, as follows.

That is, in the image forming apparatus 1 according to the first exemplary embodiment, as FIGS. 7 and 8 illustrate, the inclination of the rotating shaft of the registration roller 54a mounted on the registration unit 400 is adjusted by using the inclination adjustment member 70 at the time of shipment of a product.

In the image forming apparatus 1, a requested image is formed on the recording paper 5 under the operation by a user.

At this time, as FIG. 1 illustrates, in the image forming apparatus 1, the requested recording paper 5 is fed from the paper feeding device 50 and is transported to the second transfer position T2 of the intermediate transfer device 20 by the sheet transport roller pair 54.

The side covering part 110 is opened and closed, for example, when a transport failure (so-called jam) of the recording paper 5 occurs on, for example, the paper-feeding transport path 57, the sheet transport path 59, or the discharge transport path 65 of the image forming apparatus 1.

In the image forming apparatus 1, as described above, the inclination of the rotating shaft of the registration roller 54a mounted on the registration unit 400 is adjusted by using the inclination adjustment member 70 at the time of shipment of a product. Thus, the above adjustment operation may change the height, in the vertical direction Z, of the positioning member 85 constituting the positioning and fixing unit provided on the end portion, in the longitudinal direction, of the registration unit 400.

In the image forming apparatus 1 according to the first exemplary embodiment, when the side covering part 110 is closed, the position of the pinch unit 500 in the vertical direction Z mounted on the side covering part 110 is variable by using the main stud 82 and the first slit hole 811.

Thus, at the time of closing the side covering part 110, even when the height, in the vertical direction Z, of the registration unit 400 is changed, the height of the main stud 82 of the pinch unit 500 can be adjusted in response to the positional change of the positioning member 85 mounted on the registration unit 400. Thus, the main stud 82 of the pinch unit 500 may be reliably positioned in the positioning recess portion 851 of the positioning member 85 of the registration unit 400.

At this time, when the main stud 82 of the pinch unit 500 approaches the positioning member 85 of the registration unit 400, the main stud 82 moves in the longitudinal direction of the first slit hole 811 to the end portion 811a and is positionally restricted. Thus, even when positional variation of the main stud 82 of the pinch unit 500 is allowed, the main stud 82 is positioned relative to the positioning recess portion 851 of the positioning member 85 of the registration unit 400, and, for example, mutual interference with another member may thereby be avoided.

The main stud 82 of the pinch unit 500, after being positioned in the positioning recess portion 851 of the registration unit 400, is engaged with the fixing recess portion 863 of the fixing arm 86 to be fixed by rotating the side covering part 110 in the clockwise direction.

At this time, depending on, for example, the accuracy of positioning the inclined portion 814 of the pinch unit 500, the rotation angle until the fixing arm 86 stops in a stop position may vary.

However, in the image forming apparatus 1 according to the first exemplary embodiment, the surface, on the outer peripheral side, of the fixing recess portion 863 of the fixing arm 86 is formed into a circular arc shape around the pivot 861. Thus, even when the stop position of the fixing arm 86 varies, the main stud 82 of the pinch unit 500 is fixed in a constant position by the surface, on the outer peripheral side of the fixing recess portion 863 of the fixing arm 86, formed into a circular arc shape. As a result, the inter-axis distance of the registration roller 54a of the registration unit 400 and the pinch roller 54b of the pinch unit 500 may be maintain constant.

### Second Exemplary Embodiment

FIG. 10 illustrates a related part of an image forming apparatus according to a second exemplary embodiment of the present disclosure.

The image forming apparatus according to the second exemplary embodiment of the present disclosure, as FIG. 10 illustrates, employs, as the compression spring 84 that biases the pinch unit 500, a compression spring having a spring constant larger than that in the first exemplary embodiment, rather than setting the opening width of the first slit hole 811, at the end portion position, provided in the guide member 81 narrow.

The first slit hole 811 of the guide member 81 is formed into a narrow-and-long ellipse shape, and end portions thereof in the longitudinal direction are each formed into a circular arc shape. Thus, by using a compression spring 84 having a large spring constant, as the compression spring 84 that biases the pinch unit 500, the pressing force of the compression spring 84 may hold the position of the main stud 82 of the pinch unit 500 in the end portion 811a, in the longitudinal direction, of the first slit hole 811, when the pinch unit 500 moves to the apparatus main body 1a area.

Thus, a portion having a narrow opening width is not necessarily provided in the end portion, in the longitudinal direction, of the first slit hole 811 as in the first exemplary embodiment.

Other components and operations are similar to those of the first exemplary embodiment, and the description thereof will thus be omitted.

Although, in the exemplary embodiments, the color image forming apparatus including the four image forming devices 10Y, 10M, 10C, and 10K of yellow (Y), magenta (M), cyan (C), and black (K) is described as the image forming apparatus, this is one option, and the exemplary embodiments may also be applied in a similar manner to an image forming apparatus such as a monochrome image forming apparatus including only an image forming device of black (K).

In addition, although the case where the exemplary embodiments are applied to the side covering part as the opening and closing unit is described, this is one option, and the opening and closing unit may be any part such as a front covering part or a rear covering part as long as the transfer unit can be mounted thereon.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image forming apparatus comprising:
an opening and closing unit mounted on an apparatus main body so as to be opened and closed;
a transfer unit that is provided on the opening and closing unit and transfers an image onto a recording medium from an image holding unit at a transfer position;
a transport roller pair that transports the recording medium to the transfer position;
an inclination adjustment unit that adjusts an inclination of a first transport roller, of the transport roller pair, mounted on the apparatus main body; and
a positioning and fixing unit that, when the opening and closing unit is closed, positions and fixes a second transport roller, of the transport roller pair, movably mounted on the opening and closing unit, to the apparatus main body, before the transfer unit comes into contact with the image holding unit, the positioning and fixing unit allowing the second transport roller to move in an adjustment direction of the inclination adjustment unit and restricting a position of the second transport roller when the second transport roller moves to an end portion of an apparatus main body area of the apparatus main body.
   (((2)))

The image forming apparatus according to (((1))), wherein:
the positioning and fixing unit includes a holding unit that is provided on the opening and closing unit and, while allowing the second transport roller to move in the adjustment direction of the inclination adjustment unit, holds the second transport roller so as to move between a temporarily holding position and a transport position and
a fixing unit that is provided on the apparatus main body and positions and fixes the second transport roller in the transport position.
   (((3)))

The image forming apparatus according to (((2))), wherein:
the holding unit holds the second transport roller such that the second transport roller is movable by using a moving mechanism formed by combining a restriction member that restricts a position of the second transport roller, an elongated hole into which the restriction member is fitted, and a biasing member that biases the restriction member toward the apparatus main body.
   (((4)))

The image forming apparatus according to (((3))), wherein:
the holding unit holds the second transport roller such that the second transport roller is movable in the adjustment direction of the inclination adjustment unit by setting an opening width, of the elongated hole in a direction crossing a movement direction of the second transport roller, larger than the restriction member.
   (((5)))

The image forming apparatus according to (((3))), wherein:
the holding unit restricts a position of the second transport roller when the second transport roller moves to the end portion of the apparatus main body area, by restricting a position of the restriction member moved to an end portion of the elongated hole on the apparatus main body side.
   (((6)))

The image forming apparatus according to (((3))), wherein:
the fixing unit includes a positioning member provided in the apparatus main body area and having a first recess portion into which the restriction member is fitted and a fixing member having a second recess portion that is engaged with the restriction member to fix the restriction member in the first recess portion.
   (((7)))

The image forming apparatus according to (((6))), wherein:
the second recess portion of the fixing member is open in a direction crossing an opening direction of the first recess portion.
   (((8)))

The image forming apparatus according to (((6))), wherein:
the fixing member is constituted by a fixing arm member provided on a holding body holding the first transport roller, so as to rotate about a rotation center.
   (((9)))

The image forming apparatus according to (((8))), wherein:
the second recess portion of the fixing arm member has an engagement surface, with the restriction member, that is formed into a circular arc shape around the rotation center.

What is claimed is:

1. An image forming apparatus comprising:
an opening and closing unit mounted on an apparatus main body so as to be opened and closed;
a transfer unit that is provided on the opening and closing unit and transfers an image onto a recording medium from an image holding unit at a transfer position;
a transport roller pair that transports the recording medium to the transfer position;
an inclination adjustment unit that adjusts an inclination of a first transport roller, of the transport roller pair, mounted on the apparatus main body; and
a positioning and fixing unit that, when the opening and closing unit is closed, positions and fixes a second transport roller, of the transport roller pair, movably mounted on the opening and closing unit, to the apparatus main body, before the transfer unit comes into contact with the image holding unit, the positioning and fixing unit allowing the second transport roller to move in an adjustment direction of the inclination adjustment unit and restricting a position of the second transport roller when the second transport roller moves to an end portion of an apparatus main body area of the apparatus main body.

2. The image forming apparatus according to claim 1, wherein:
the positioning and fixing unit includes a holding unit that is provided on the opening and closing unit and, while allowing the second transport roller to move in the adjustment direction of the inclination adjustment unit, holds the second transport roller so as to move between a temporarily holding position and a transport position and
a fixing unit that is provided on the apparatus main body and positions and fixes the second transport roller in the transport position.

3. The image forming apparatus according to claim 2, wherein:
the holding unit holds the second transport roller such that the second transport roller is movable by using a moving mechanism formed by combining a restriction member that restricts a position of the second transport roller, an elongated hole into which the restriction member is fitted, and a biasing member that biases the restriction member toward the apparatus main body.

4. The image forming apparatus according to claim 3, wherein:
the holding unit holds the second transport roller such that the second transport roller is movable in the adjustment direction of the inclination adjustment unit by setting an opening width, of the elongated hole in a direction crossing a movement direction of the second transport roller, larger than the restriction member.

5. The image forming apparatus according to claim 3, wherein:
the holding unit restricts a position of the second transport roller when the second transport roller moves to the end portion of the apparatus main body area, by restricting a position of the restriction member moved to an end portion of the elongated hole on the apparatus main body side.

6. The image forming apparatus according to claim 3, wherein:
the fixing unit includes a positioning member provided in the apparatus main body area and having a first recess portion into which the restriction member is fitted and a fixing member having a second recess portion that is engaged with the restriction member to fix the restriction member in the first recess portion.

7. The image forming apparatus according to claim 6, wherein:
the second recess portion of the fixing member is open in a direction crossing an opening direction of the first recess portion.

8. The image forming apparatus according to claim 6, wherein:
the fixing member is constituted by a fixing arm member provided on a holding body holding the first transport roller, so as to rotate about a rotation center.

9. The image forming apparatus according to claim 8, wherein:
the second recess portion of the fixing arm member has an engagement surface, with the restriction member, that is formed into a circular arc shape around the rotation center.

10. An image forming apparatus comprising:
opening and closing means mounted on an apparatus main body so as to be opened and closed;
transfer means for transferring an image onto a recording medium from image holding means at a transfer position, the transfer means being provided on the opening and closing means;
a transport roller pair that transports the recording medium to the transfer position;
inclination adjustment means for adjusting an inclination of a first transport roller, of the transport roller pair, mounted on the apparatus main body; and
positioning and fixing means for, when the opening and closing means is closed, positioning and fixing a second transport roller, of the transport roller pair, movably mounted on the opening and closing means, to the apparatus main body, before the transfer means comes into contact with the image holding means, the positioning and fixing means allowing the second transport roller to move in an adjustment direction of the inclination adjustment means and restricting a position of the second transport roller when the second transport roller moves to an end portion of an apparatus main body area of the apparatus main body.
